(19) United States
(12) Patent Application Publication
(10) Pub. No.: US 2007/0193846 A1
(43) Pub. Date: Aug. 23, 2007

(54) Axial setting device

(76) Inventors: Artur Grunwald, Numbrecht (DE); Hans-Peter Nett, Adenau (DE); Theodor Gassmann, Siegburg (DE); Bernhard Terfloth, Remscheid (DE); Josef Bachmann, Obersinn (DE)

Correspondence Address: Dickinson Wright PLLC, 38525 Woodward Avenue, Suite 2000, Bloomfield Hills, MI, 48304, US

(21) Appl. No.: 10/575,730

(22) PCT Filed: Sep. 25, 2004
(86) PCT No.: PCT/EP04/10788

§ 371 Date: Dec. 21, 2006

(30) Foreign Application Priority Data
Oct. 13, 2003 (DE) 103 49 030.2

(51) Int. Cl. F16D 25/06

(52) U.S. Cl. 192/85 AA

(57) ABSTRACT

An axial setting device for actuating a multi-plate coupling (2) in the driveline of a motor vehicle, comprising a housing (3), a cylinder unit (15) and a hydraulic system. In the housing (3), two parts (4, 5) are supported so as to be coaxially rotatable relative to one another and can be coupled to one another by a set of coupling plates (10) which are axially arranged between a supporting disc (9) and a pressure disc (11). The cylinder unit (15) comprises a hydraulic chamber (22) and a piston (21) axially displaceably arranged therein for actuating the multi-plate coupling (10) via the pressure disc (11). The hydraulic system for actuating the piston (21) comprises a quantity of oil jointly contained in the housing (3) and in the hydraulic chamber (22), as well as a pump (18) which has a first connection (23) connected to the housing (3) and a second connection (24) connected to the hydraulic chamber (22).

### TECHNICAL FIELD

The invention relates to an axial setting device, more particularly for actuating a multi-plate coupling whose friction plates are alternately connected to the one and the other of two parts rotatable relative to one another, which friction plates are connected so as to be axially displaceable, and which friction plates rest against an axially fixed supporting disc and can be pressure-loaded by an axially displaceable pressure disc. Setting devices of said type combined with said multi-plate coupling are known in different embodiments and for different applications.

### BACKGROUND

U.S. Pat. No. 6,927,376, for example, describes an axial setting device with ball ramp configurations. It comprises ball grooves with pitches extending in opposite directions in setting disc and pressure disc surfaces which face one another and between which there are held balls. A motor inserted into the housing can be used to rotate the setting disc relative to the pressure disc, so that the distance between the two disc changes, as a result of which the friction plates of the multi-plate coupling are axially loaded.

From U.S. Pat. No. 6,581,741, there is known an axial setting device with a hydraulic pump for loading the friction plates of a friction coupling or for fixing the viscous plates of a viscous coupling. When the two coupling parts rotate relative to one another, the pump conveys oil from a reservoir into a pressure chamber which is delimited by an axial piston. The oil can return from the pressure piston back into the reservoir through a bypass which is controlled by a solenoid valve.

### SUMMARY OF THE INVENTION

It is an object of the invention to propose an axial setting device of the initially mentioned type which features a simple design, short reaction times and a small size and thus is also lightweight.

In accordance with an embodiment of the invention, an axial setting device for actuating a multi-plate coupling in the driveline of a motor vehicle is provided. The device includes a housing in which there are supported two parts so as to be coaxially rotatable relative to one another, which two parts can be coupled to one another by the multi-plate coupling arranged in the housing; a cylinder unit with a hydraulic chamber and a piston which is arranged in the hydraulic chamber so as to be axially displaceable and which is provided for actuating the multi-plate coupling; a hydraulic system for supplying the cylinder unit, comprising a quantity of oil jointly contained in the housing and in the hydraulic chamber, the hydraulic system further comprising a pump which comprises a first connection connected to the housing and a second connection connected to the hydraulic chamber.

Such an axial setting device is advantageous in that it is small and lightweight. Furthermore, the reaction time, i.e. the time passing between the activation of the pump and the loading of the pressure disc, is short, so that the multi-plate coupling can be switched quickly to adapt to changing driving conditions of the motor vehicle. Furthermore, it is advantageous that there is only one oil circuit which serves both to set the pressure disc and to lubricate and to cool the multi-plate coupling operating under wet conditions in the housing. The pump comprises a motor which is connected to an electronic control unit for controlling the driving dynamics of the motor vehicle. If the multi-plate coupling needs to be switched, the motor is activated by the control unit in such a way that oil is conveyed from the oil bath in the housing into the hydraulic chamber. The piston is displaced towards the pressure disc which, in turn, loads the coupling plates. The pump is designed in such a way that oil can be conveyed from the housing into the hydraulic chamber and, if necessary, from the hydraulic chamber into the housing. This may be the case if as a result of the control of the driving dynamics of the motor vehicle, the multi-plate coupling has to be quickly disconnected.

The pump can be firmly connected to the housing, wherein, in the housing, there is provided an aperture connecting the first connection to the interior of the housing and a channel connecting the second connection to the hydraulic chamber. The channel can be provided in the housing only and the aperture ends in an antechamber which is formed by a cylindrical projection of the housing, in which projection there is arranged the pump. In a particular embodiment of the invention, a filter element serving to filter particles out of the oil is provided in the hydraulic system between the housing and the first connection of the pump. Said filter element can be arranged either in the aperture of the housing or, according to an alternative embodiment, it may be associated with the first connection of the pump.

According to another embodiment of the invention, a pressure sensor connected to the electronic control unit is arranged between the second connection and the hydraulic chamber. Inter alia, the control unit serves to control the internal pressure in the hydraulic chamber, with the value recorded by the pressure sensor being used as the input value. If, for example as a result of leakage losses at the hydraulic piston or as a result of wear of the coupling plates, the pressure sensor records changes in pressure in the hydraulic chamber, the control unit would react such as to introduce additional oil. Furthermore, the pressure sensor and the control unit can be used to hold the pressure at a constant value. In addition to the pressure sensor or as an alternative, a check valve controllable by the control unit can be provided between the second connection and the hydraulic chamber; it prevents the oil from returning from the hydraulic chamber into the pump, so that the pressure on the piston is held at a constant level. If it is necessary that the oil returns from the hydraulic chamber into the housing, the check valve is released by the control unit.

The pump can be an internal gear pump which comprises a hollow gear with an internal trochoid and a rotor with an external trochoid running eccentrically on a circuit. The hollow gear, along its internal trochoid, comprises a plurality of partially cylindrical recesses in which gears are rotatably held and the rotor, along its external trochoid, comprises a toothed structure which engages the teeth of the gears. This type of design based on the principle of an internal gear pump is advantageous in that leakages and pulsation are reduced. Furthermore, it is characterized by a high degree of efficiency and is relatively cost-effective.

According to a further embodiment of the invention, the pump and the electric motor form one unit and are positioned on a common longitudinal axis. The pump rotor is driven by activating the electric motor. When the rotor rotates relative to the hollow gear—depending on the direction of rotation—there is generated a volume flow to the first or second connection, so that oil is pumped from the housing into the hydraulic chamber or from the hydraulic chamber into the housing.

### BRIEF DESCRIPTION OF THE DRAWINGS

A preferred embodiment of the invention is illustrated in the drawings wherein

FIG. 1 is a longitudinal section through an inventive axial setting device with a pump.

FIG. 2 is a plan view of the pump according to FIG. 1 in an exploded perspective view.

FIG. 3 is a cross-section through the pump according to FIG. 2.

### DETAILED DESCRIPTION

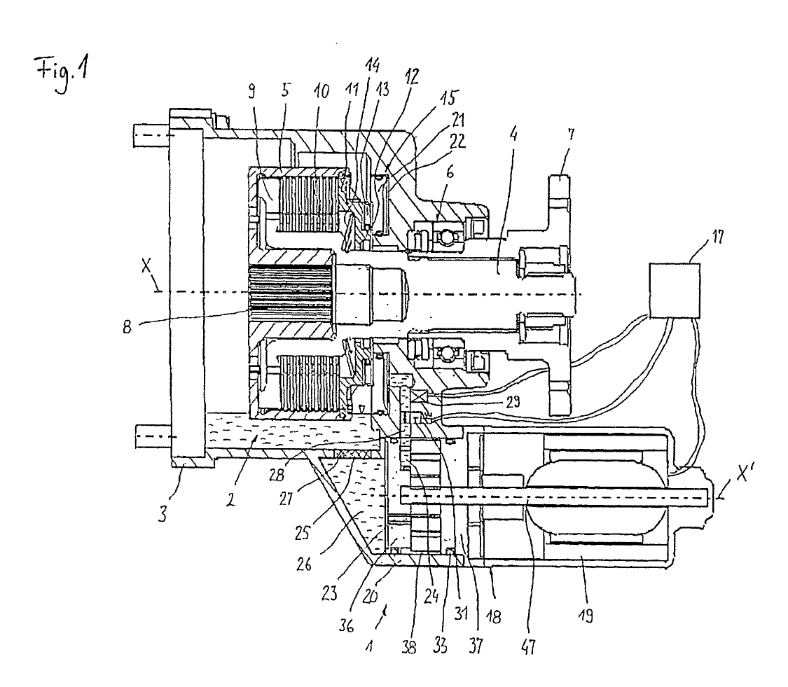

FIG. 1 shows an axial setting device 1 which includes a multi-plate coupling 2. The coupling device formed thereby is arranged in a fixed housing 3. The multi-plate coupling 2 comprises two parts, i.e. a shaft 4 and a carrier 5, which two parts are rotatable relative to one another. A bearing assembly 6 which comprises a radial bearing and an axial bearing serves to support the multi-plate coupling 2 in the housing 3. The multi-plate coupling 2 comprises inner plates directly held in a rotationally fast way on outer teeth of the shaft 4, and outer plates directly held in a rotationally fast way in the carrier 5 on inner teeth. Via engaging teeth, the shaft 4 is connected to the flange 7 provided for being attached to a driveline. The carrier 5 which, by a sleeve portion, is axially immovably and rotatably supported in a hub portion of the shaft 4 comprises inner teeth 8 for inserting a shaft (not illustrated). The coupling plates 10 are supported on a supporting disc 9 which is firmly connected to the shaft 4. By a pressure disc 11, which is cover-shaped, said coupling plates 10 are loaded by an axial bearing 13 arranged on a step 12 of the pressure disc 11. Between the pressure disc 11 and the shaft 4, there is a spring 14 in the form of Belleville spring washers which load the supporting disc 9 and the pressure disc 11 in axially opposed directions. In the condition as illustrated, the inner plates and outer plates are not in contact with one another, so that the shaft 4 is able to rotate freely relative to the carrier 5.

The axial setting device 1 comprises a cylinder unit 15 and a hydraulic system with a pump 18 for actuating the cylinder unit 15. The cylinder unit 15 comprises a piston 21 which is sealingly arranged in a hydraulic chamber 22 and is held so as to be axially displaceable. The pump 18 comprises an electric motor 19 which can be controlled via an electronic control unit 17, a first connection 23 connected to the housing 3 as well as a second connection 24 connected to the hydraulic chamber 22. The pump 18 is designed in such a way that it is able to convey oil from the housing 3 to the hydraulic chamber 22 and, vice versa, from the hydraulic chamber 22 to the housing 3. In this way, there is formed an open hydraulic system with two interconnected chambers.

The housing 3 is provided with an aperture 25 which permits the supply of oil from the interior of the housing 3 to the first connection 23. The housing comprises a projection 20 in which the pump is sealingly accommodated, so that there is formed an antechamber which the aperture 25 meets with. According to a first embodiment, the aperture 25 receives a filter element 27 which filters impurities out of the oil. The second connection 24 of the pump 18 ends in a channel 28 which, in turn, is connected to the hydraulic chamber 22.

In the housing 3, there is arranged a pressure sensor 29 which serves to measure the internal pressure in the hydraulic chamber 22 and in the channel 28 respectively and which is connected to the control unit 17. When the pressure in the hydraulic chamber 22 drops, for example as a result of leakage losses at the piston 21 or wear at the coupling plates 10, the pump 18 can be activated by the electronic control unit 17 for the purpose of pumping additional oil into the hydraulic chamber 22. In the channel 28, between the pump 18 and the hydraulic chamber 22, there is provided a controllable check valve 31 which prevents oil from returning from the hydraulic chamber 22 back towards the pump 18. If a backflow of oil from the hydraulic chamber 22 into the housing 3 is necessary, the check valve 31 is opened by the control unit 17. In this way, the pressure in the hydraulic chamber 22 is reduced and the piston is axially released. The spring 14 of the multi-plate coupling 2 now again loads the pressure disc 11 and the supporting disc 9 in opposed directions, so that the multi-plate coupling 2 is ventilated, with the shaft 4 being able to freely rotate relative to the carrier 5. If, due to special driving conditions, it is necessary for the oil to return from the hydraulic chamber 22 into the housing 3, the oil flow can be accelerated by reversing the direction of rotation of the pump 18. For this purpose, the pump 18 is activated accordingly by the control unit 17, with the check valve 31 simultaneously being opened.

The pump 18 which is shown in detail in FIG. 2 comprises a cover 36, a base 37 and, arranged therebetween, a set of pump gears 38 with an outer ring 40 which, jointly, form a cylindrical portion which is accommodated in the pipe-shaped projection 20 of the housing 3. Seals 33 are received in grooves which are arranged in circumferential faces of the cover 36 and of the base 37 and which prevent oil from leaving the housing 3 and dirt from penetrating into the housing 3. In the cover 36 of the pump housing, there are formed the first connection 23 and the second connection 24 which are connected to the housing 3 and to the hydraulic chamber 22 respectively. In front of the first connection 23, a filter element 35 is attached to the cover 36 and filters impurities out of the oil. To that extent, the embodiment shown in FIG. 2 represents an alternative or addition to the embodiment according to FIG. 1 in that, in FIG. 1, the filter element 27 is arranged in the aperture 25 of the housing 3. At the base 37, there is attached a flange 34 which, together with a flange at the housing of the electric motor 19, serves to fix the pump 18 to the housing 3 fasteners.

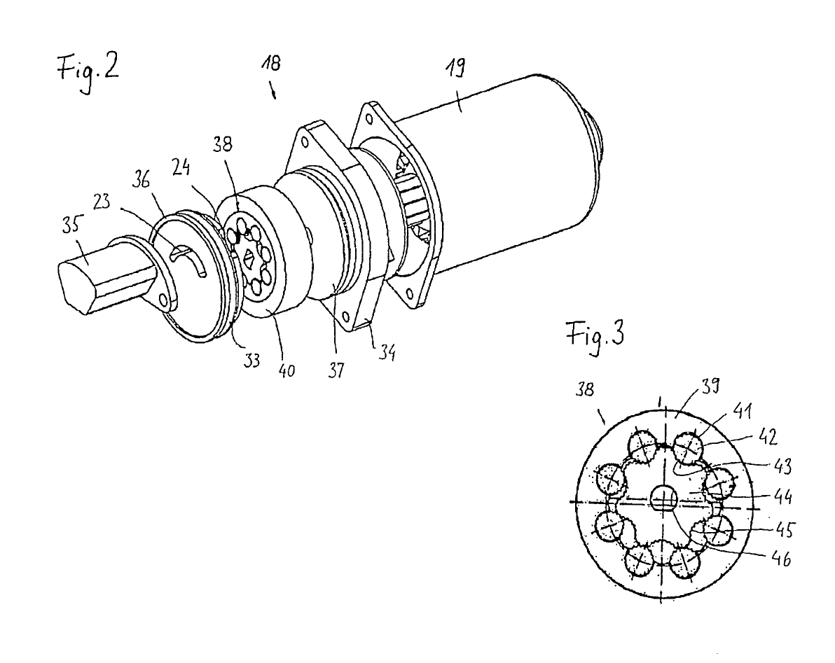

Between the cover 36 and the base 37, in the outer ring 40, there is arranged the set of pump gears 38 which, in a cross-sectional view, is shown in FIG. 3. It comprises a hollow gear 39 with an internal trochoid 43 and a plurality of circumferentially uniformly distributed recesses 41, gears 42 which are rotatably received in the recesses 41, and a rotor 44 with an external trochoid 45. The gears 42, in total, form inner teeth 43 in the hollow gear 38, which inner teeth 43 are engaged by the outer teeth of the rotor 44. The rotor 44 comprises a bore 46 into which there is inserted a driveshaft 47 of the electric motor 19 for the purpose of transmitting torque. The set of pump gears 38, which is driven by the driveshaft 47, rotates eccentrically relative to the longitudinal axis of the pump 18. In this way, depending on the direction of rotation of the driveshaft 47, oil is pumped from the first connection 23 to the second connection 24 or, vice versa, from the second connection 24 to the first connection 23.

What is claimed is:

1.-14. (canceled)

15. An axial setting device for actuating a multi-plate coupling in the driveline of a motor vehicle, comprising:
a housing in which there are supported two parts so as to be coaxially rotatable relative to one another, which two parts can be coupled to one another by the multi-plate coupling arranged in the housing;
a cylinder unit with a hydraulic chamber and a piston which is arranged in the hydraulic chamber so as to be axially displaceable and which is provided for actuating the multi-plate coupling; and
a hydraulic system for supplying the cylinder unit, comprising a quantity of oil jointly contained in the housing and in the hydraulic chamber, and a pump having a first connection connected to the housing and a second connection connected to the hydraulic chamber.

16. An axial setting device according to claim 15, wherein the pump is adapted to convey oil from the housing to the hydraulic chamber and vice versa.

17. An axial setting device according to claim 15, wherein the pump is firmly connected to the housing and, in the housing, there is provided an aperture connecting the first connection to an interior of the housing and a channel connecting the second connection to the hydraulic chamber.

18. An axial setting device according to claim 16, wherein the pump is firmly connected to the housing and, in the housing, there is provided an aperture connecting the first connection to an interior of the housing and a channel connecting the second connection to the hydraulic chamber.

19. An axial setting device according to claim 17 comprising an antechamber in the housing between the aperture and the first connection.

20. An axial setting device according to claim 18 comprising an antechamber in the housing between the aperture and the first connection.

21. An axial setting device according to claim 17, wherein the channel is provided in the housing only.

22. An axial setting device according to claim 15 comprising a filter in the hydraulic system between the housing and the first connection of the pump.

23. An axial setting device according to claim 17 comprising a filter in the hydraulic system between the housing and the first connection of the pump.

24. An axial setting device according to claim 19 comprising a filter in the hydraulic system between the housing and the first connection of the pump.

25. An axial setting device according to claim 23, wherein the filter element is provided in the aperture.

26. An axial setting device according to claim 24 wherein the filter element is provided in the aperture.

27. An axial setting device according to claim 22, wherein the filter element is associated with the first connection of the pump.

28. An axial setting device according to claim 15 comprising a pressure sensor between the second connection and the hydraulic chamber, the pressure sensor being connected to an electronic control unit.

29. An axial setting device according to claim 17 comprising a pressure sensor between the second connection and the hydraulic chamber, the pressure sensor being connected to an electronic control unit.

30. An axial setting device according to claim 19 comprising a pressure sensor between the second connection and the hydraulic chamber, the pressure sensor being connected to an electronic control unit.

31. An axial setting device according to claim 15 comprising a controllable check valve between the second connection and the hydraulic chamber.

32. An axial setting device according to claim 15, wherein the pump is an internal gear pump and comprises a hollow gear with an internal trochoid and a rotor with an external trochoid.

33. An axial setting device according to claim 32, wherein the internal trochoid of the hollow gear is formed by a plurality of rotatable gears being inserted in partially cylindrical recesses of the hollow gear and the rotor, along its external trochoid, comprises a toothed structure which engages the teeth of the rotatable gears.

34. An axial setting device according to claim 15, wherein the pump can be driven by an electric motor and is controllable by an electronic control unit.

35. An axial setting device according to claim 34, wherein the pump and the electric motor form one unit and are positioned on a common longitudinal axis.
